(19) United States
(12) Patent Application Publication
(10) Pub. No.: US 2014/0162049 A1
(43) Pub. Date: Jun. 12, 2014

(54) POLYDIMETHYL SILOXANE SOL, SURFACE TREATMENT METHOD FOR METAL SUBSTRATE USING THE POLYDIMETHYL SILOXANE SOL AND ARTICLE MANUFACTURED BY THE METHOD

(71) Applicants: SHENZHEN FUTAIHONG PRECISION INDUSTRY CO., LTD., (US); FIH (HONG KONG) LIMITED, Kowloon (HK)

(72) Inventors: TING DING, Shenzhen (CN); CHAO-YI YU, Shenzhen (CN); DA-HUA CAO, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/726,582

(22) Filed: Dec. 25, 2012

(30) Foreign Application Priority Data
Dec. 11, 2012 (CN) 201210529807.5

(51) Int. Cl. C09D 5/00

(52) U.S. Cl. CPC C09D 5/00
USPC 428/313.9; 106/287.14; 427/387

(57) ABSTRACT

A polydimethyl siloxane sol includes polydimethyl siloxane, isopropyl alcohol, ethanol, fumed silicon dioxide, hydrochloric acid, and water. A surface treatment method for a metal substrate using the polydimethyl siloxane sol and a coated article manufactured by the method is also provided.

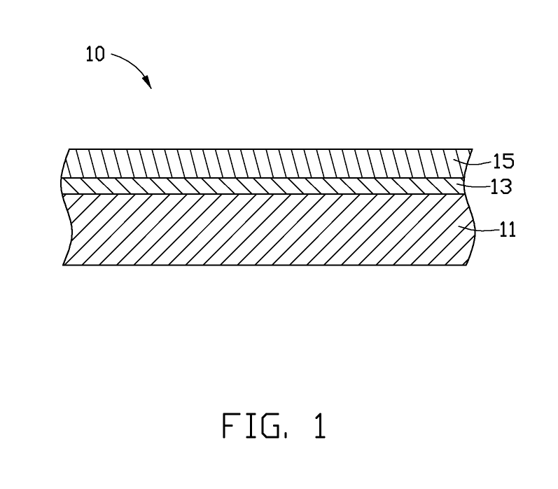

### BACKGROUND

1. Technical Field

The present disclosure relates to a polydimethyl siloxane sol, a surface treatment method for metal substrates using the polydimethyl siloxane sol, and articles manufactured by the surface treatment method.

2. Description of Related Art

Aluminum and aluminum alloy are widely used, but are prone to corrosion because the aluminum or aluminum alloy has a very low standard electrode potential. To protect the underlying aluminum or aluminum alloy from corrosion, an insulating layer may be formed between the aluminum or aluminum alloy and a vacuum deposited protective layer for the purpose of preventing galvanic corrosion in the layers and corrosion reaching the aluminum or aluminum alloy. However, since the layers often have pinholes and cracks therein, the corrosive agents can permeate the layers creating a galvanic cell in the protective layer and the aluminum or aluminum alloy. The protective layer may then become a cathode of the galvanic cell and the aluminum or aluminum alloy an anode. When a surface area of the cathode is larger than the surface area of the anode (a small portion of the surface of the aluminum or aluminum alloy), a large current of the galvanic cell will be created in the protective layer and the aluminum or aluminum alloy. Then, both the protective layer and the aluminum or aluminum alloy are quickly corroded.

Therefore, there is room for improvement within the art.

### BRIEF DESCRIPTION OF THE DRAWINGS

Many aspects of the embodiment can be better understood with reference to the drawing. The components in the drawing are not necessarily drawn to scale, the emphasis instead being placed upon clearly illustrating the principles of the exemplary disclosure.

The FIGURE is a cross-sectional view of an exemplary embodiment of an article coated with a polydimethyl siloxane gel layer.

### DETAILED DESCRIPTION

According to an exemplary embodiment, a polydimethyl siloxane sol substantially includes polydimethyl siloxane, isopropyl alcohol, fumed silicon dioxide, aluminum hydroxide, hydrochloric acid, and water, wherein the volume percentage of the polydimethyl siloxane is about 40% to about 50%, the volume percentage of the isopropyl alcohol is about 10% to about 15%, the volume percentage of the fumed silicon dioxide is about 5% to about 10%, the volume percentage of the aluminum hydroxide is about 5% to about 10%, the volume percentage of the hydrochloric acid is about 3% to about 5%, and the volume percentage of water is about 10% to about 30%. The pH value of the polydimethyl siloxane sol is about 3 to about 5.

Hydrochloric acid acts as a catalyst to provide H₃O⁺ ions to promote the film formation of the polydimethyl siloxane. The hydrochloric acid is to adjust the pH value of the polydimethyl siloxane sol.

A surface treatment method for metal substrate using the polydimethyl siloxane sol may at least include the following steps:

Referring to the figure, a metal substrate 11 is provided. The metal substrate 11 may be made of aluminum, aluminum alloy, magnesium, or magnesium alloy.

A polydimethyl siloxane gel layer 13 is formed on the metal substrate 11. Forming the polydimethyl siloxane gel layer 13 may include the following steps:

A polydimethyl siloxane sol layer is first formed on the metal substrate 11 by coating or immersing. Then the polydimethyl siloxane sol layer is heated to form the polydimethyl siloxane gel layer 13. The heating process is carried out in a furnace (not shown). During the heating process, the furnace is pre-heated to about 70° C. to about 90° C. The metal substrate 11 is placed in the furnace, and the internal temperature of the furnace is maintained at about 70° C. to about 90° C. for about 10 min to about 20 min. Then the internal temperature of the furnace is increased to between about 160° C. to 180° C. and kept in that temperature range for about 10 min to about 20 min. The polydimethyl siloxane gel layer 13 has a thickness of about 3 μm to about 6 μm.

During the heating treatment, the polydimethyl siloxane aggregates into a network structure. The fumed silicon dioxide chemically bonds with the polydimethyl siloxane to a large extent. Due to the fumed silicon dioxide being a porous material, polydimethyl siloxane is prone to physical adherence and crystallization in the fumed silicon dioxide, which provides an improved density and corrosion resistance to the polydimethyl siloxane gel layer 13. Additionally, the crystallized polydimethyl siloxane enhances the hardness and strength of the polydimethyl siloxane gel layer 13.

A color layer 15 is formed on the polydimethyl siloxane gel layer 13 by physical vapor deposition. The color layer 15 can be a layer of chromium-carbon (CrC), titanium-nitrogen-oxygen (TiNO), titanium-carbon-nitrogen (TiCN), titanium nitride (TiN), chromium-nitrogen-oxygen (CrNO), chromium-carbon-nitrogen (CrCN), or any other cosmetic layers formed by physical vapor deposition. Alternatively, the color layer 15 may be a functional layer formed by physical vapor deposition.

The figure shows an article 10 which includes a metal substrate 11, a polydimethyl siloxane gel layer 13 formed on the metal substrate 11, and a color layer 15 formed on the polydimethyl siloxane gel layer 13.

The polydimethyl siloxane gel layer 13 includes a network structure formed by the polydimethyl siloxane and the fumed silicon dioxide, and the network structure is filled in with aluminum hydroxide. Fumed silicon dioxide has a porous structure. Polydimethyl siloxane physically adheres to the fumed silicon dioxide, and/or chemically bonds with the fumed silicon dioxide to form Si—O bonds.

The polydimethyl siloxane gel layer 13 has a thickness of about 3 μm to about 6 μm.

The color layer 15 is formed on the polydimethyl siloxane gel layer 13 by physical vapor deposition. The color layer 15 can be a layer of CrC, TiNO, TiCN, TiN, CrNO, CrCN, or any other cosmetic layers formed by physical vapor deposition. Alternatively, the color layer 15 may be a functional layer formed by physical vapor deposition.

The polydimethyl siloxane gel layer 13 formed between the metal substrate 11 and the color layer 15 prevents oxygen and an electrolyte solution from diffusing through to the metal substrate 11, thus improving the corrosion resistance of the article 10. Additionally, when temperature is above 200° C., the aluminum hydroxide will be thermally decomposed into Al₂O₃ and 3H₂O, and the H₂O absorbs an amount of heat to reduce the surface temperature of the polydimethyl siloxane gel layer 13, which enhances the heat resistance of the article 10.

### EXAMPLE 1

A metal substrate 11 was provided. The metal substrate 11 was made of aluminum alloy.

A polydimethyl siloxane sol was provided. In the polydimethyl siloxane sol, the volume percentage of the polydimethyl siloxane was about 50%, the volume percentage of the isopropyl alcohol was about 10%, the volume percentage of the fumed silicon dioxide was about 10%, the volume percentage of the aluminum hydroxide was about 8%, the volume percentage of the hydrochloric acid was about 5%, and the volume percentage of water was about 17%. The pH value of the polydimethyl siloxane sol was about 3.5.

A polydimethyl siloxane gel layer 13 was formed on the metal substrate 11 as follows:

A polydimethyl siloxane sol layer was formed on the metal substrate by coating.

The polydimethyl siloxane gel was heated to form the polydimethyl siloxane gel layer 13. The metal substrate 11 was placed in the furnace for about 12 mins, and the internal temperature of the furnace was maintained at about 90° C. The internal temperature of the furnace was increased to 180° C. and maintained at that temperature for about 20 mins. The polydimethyl siloxane gel layer 13 has a thickness of about 3 μm to 6 μm.

The color layer 15 was formed on the polydimethyl siloxane gel layer 13. The color layer 15 was a CrN layer.

### COMPARISON EXAMPLE

Unlike example 1, a comparison example had no polydimethyl siloxane gel layer 13 between the metal substrate 11 and the color layer 15. Except for the above difference, the other experimental conditions for the comparison example were the same as in example 1.

### RESULTS OF EXAMPLE 1 AND THE COMPARISON EXAMPLE

A salt spray test was performed on the articles formed by the example 1 and the comparison example. The salt spray test used a sodium chloride (NaCl) solution having a mass concentration of 5% at a temperature of 35° C. The test indicated that the corrosion resistance of the article of example 1 lasted longer than 168 hours (h), and the corrosion resistance of the article of the comparison example lasted 120 h. Thus, the article of example 1 had a better and improved corrosion resistance property.

It is to be understood, however, that even through numerous characteristics and advantages of the exemplary disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A polydimethyl siloxane sol, comprising:
polydimethyl siloxane;
isopropyl alcohol;
fumed silicon dioxide;
hydrochloric acid; and
water.

2. The polydimethyl siloxane as claimed in claim 1, wherein in the polydimethyl siloxane sol, the volume percentage of the polydimethyl siloxaneis about 40% to about 50%, the volume percentage of the isopropyl alcohol is about 10% to about 15%, the volume percentage of the fumed silicon dioxide is about 5% to about 10%, the volume percentage of the hydrochloric acid is about 3% to about 5%, and the volume percentage of the water is about 10% to about 30%.

3. The polydimethyl siloxane sol as claimed in claim 1, wherein the pH value of the polydimethyl siloxane sol is about 3 to about 5.

4. The polydimethyl siloxane sol as claimed in claim 1, further comprising aluminum hydroxide.

5. The polydimethyl siloxane sol as claimed in claim 4, wherein in the polydimethyl siloxane sol, the volume percentage of the aluminum hydroxide is about 5% to about 10%.

6. A surface treatment method for metal substrate using the polydimethyl siloxane sol, comprising:
providing a metal substrate;
providing a polydimethyl siloxane sol, the polydimethyl siloxane sol comprising polydimethyl siloxane, isopropyl alcohol, fumed silicon dioxide, hydrochloric acid, and water;
forming a polydimethyl siloxane sol layer on the metal substrate;
heating the polydimethyl siloxane sol layer to form a polydimethyl siloxane gel layer on the metal substrate, the polydimethyl siloxane gel layer comprising a network structure formed by polydimethyl siloxane, fumed silicon dioxide, and aluminum hydroxide filled in the network structure; the fumed silicon dioxide having a porous structure; polydimethyl siloxane physical being adhered to the fumed silicon dioxide, and/or chemically bonded to the fumed silicon dioxide to form Si—O bonds.

7. The surface treatment method as claimed in claim 6, wherein in the polydimethyl siloxane sol, the volume percentage of the polydimethyl siloxaneis about 40% to about 50%, the volume percentage of the isopropyl alcohol is about 10% to about 15%, the volume percentage of the fumed silicon dioxide is about 5% to about 10%, the volume percentage of the hydrochloric acid is about 3% to about 5%, and the volume percentage of the water is about 10% to about 30%.

8. The surface treatment method as claimed in claim 6, wherein the polydimethyl siloxane sol further comprises aluminum hydroxide.

9. The surface treatment method as claimed in claim 8, wherein in the polydimethyl siloxane sol, the volume percentage of aluminum hydroxide is about 5% to about 10%.

10. The surface treatment method as claimed in claim 6, further comprising a step of forming a color layer on the polydimethyl siloxane gel layer.

11. The surface treatment method as claimed in claim 6, wherein the polydimethyl siloxane sol layer is heated as follows: the metal substrate is positioned in a furnace for about 10 min to about 15 min, the internal temperature of the furnace is about 70° C. to about 90° C.; then the internal temperature of the furnace is increased to 160° C. to about 180° C. and maintained in that temperature range for about 10 min to about 20 min.

12. An article, comprising:
a metal substrate; and
a polydimethyl siloxane gel layer formed on the metal substrate, the polydimethyl siloxane gel layer comprising a network structure formed by polydimethyl siloxane, fumed silicon dioxide, and aluminum hydroxide filled in the network structure; the fumed silicon dioxide having a porous structure, polydimethyl siloxane physical being adhered to the fumed silicon dioxide, and/or chemically bonded to the fumed silicon dioxide to form Si—O bonds.

13. The article as claimed in claim 12, wherein the polydimethyl siloxane gel layer further comprises aluminum hydroxide.

14. The article as claimed in claim 12, further comprising a color layer on the polydimethyl siloxane gel layer, the color layer is a physical vapor deposition layer.

15. The article as claimed in claim 14, wherein the color layer is a layer of chromium-carbon, titanium-nitrogen-oxygen, titanium-carbon-nitrogen, titanium nitride, chromium-nitrogen-oxygen, or chromium-carbon-nitrogen.

16. The article as claimed in claim 12, wherein the polydimethyl siloxane gel layer has a thickness of about 3 μm to about 6 μm.
